(19) United States
(12) Patent Application Publication
(10) Pub. No.: US 2006/0230234 A1
(43) Pub. Date: Oct. 12, 2006

(54) Browser cache management

(75) Inventors: Ariel Bentolila, Ramat Hasharon (IL); Gennady Shumakher, Hod Hasharon (IL); Dmitry Kagan, Kfar Sava (IL)

Correspondence Address: ABELMAN, FRAYNE & SCHWAB, 150 East 42nd Street, New York, NY, 10017-5612, US

(73) Assignee: SAP AG.

(21) Appl. No.: 11/094,733

(22) Filed: Mar. 30, 2005

(51) Int. Cl. G06F 13/28; G06F 15/16

(52) U.S. Cl. 711/133; 709/217

(57) ABSTRACT

The management of a browser cache is modified, such that when the browser is closed, only those cache files that are classified as potential security risks are erased. Other cache files are not deleted. File classification is based upon matching regular expressions consisting of the entries with a set of qualified content sources, and a set of qualified file names in the cache. Every cache file that fails to match at least one member of the set of content sources and one member of the set of file names is deleted upon browser close. An editable settings file contains the qualified content sources and the qualified file names.

### BACKGROUND OF THE INVENTION

1. Field of the Invention

This invention relates to data communication using browsers. More particularly, this invention relates to improvements in browser cache management.

2. Description of the Related Art

SAP, the SAP Logo, R/2, R/3, mySAP, mySAP.com and other SAP products and services that may be mentioned herein as well as their respective logos are trademarks or registered trademarks of SAP AG or its affiliates in Germany and in other countries.

Browsers have become a standard application for personal computers. Well-known commercially available browsers include Microsoft Internet Explorer®, Netscape Navigator®, Opera®, Firefox®, and Safari®. Browsers can be used on data networks, for example, the Internet, in order to search for content, which can be stored in different formats, e.g., HTML documents, JPEG and GIF images. Browsers are also effectively used within more specialized environments and platforms. For example, Internet Explorer and other browsers are supported by the mySAP Enterprise Portal, available from SAP AG, Neurottstraβe 16, 69190 Waldorf, Federal Republic of Germany. Enterprise Portal provides several functions, including unified access to the data stores of an enterprise, content management services, and search and classification functions. Many of the data stores can be viewed using a browser.

A browser typically requires the use of the host computer's memory, such as its hard drive, for temporary caching of content. A browser cache is a reserved area, which stores content that has been previously retrieved by the browser. Using the cache, recently viewed content can be quickly be retrieved. This content need not be reloaded from a remote server, which can be a relatively slow process. The browser cache is thus an important factor in browser performance, and its use saves considerable time for the operator.

### SUMMARY OF THE INVENTION

Because the content of recently visited locations persists in the browser cache, a security problem is presented when a browser is used to access confidential content. One way of dealing with this problem is to use the browser cache deletion option provided by Microsoft Internet Explorer, for example. Activating this option causes the browser cache to be entirely deleted whenever the browser is closed. This behavior is endorsed by the security policies of corporations and other organizations using Internet Explorer. Unfortunately, deletion of the browser cache lengthens the response time of the browser when the user revisits a location in a subsequent session, as many files and objects must once again be downloaded from a remote server.

According to a disclosed embodiment of the invention, the management of a browser cache is modified, such that when the browser is closed, only certain cache files are erased, but other cache files are not deleted. For example, cache files that are classified as potential security risks may be chosen for erasure or, alternatively, cache files of types that do not pose a security risk may be preserved, while all other cache files are erased. For example, in the latter case, file classification may be based upon matching regular expressions with a set of qualified hosts or content sources, and/or with a set of qualified file names in the cache. In one aspect of the invention, every file that fails to match at least one member of the set of qualified content sources and/or one member of the set of qualified file names is deleted upon termination of the browser session. An editable settings file contains the qualified content sources and the qualified file names.

An advantage of some aspects of the present invention is that companies that require the browser cache to be deleted upon closing the browser can now more selectively delete cache files, leaving static and non-sensitive files in the cache, thus enhancing browser performance.

The invention provides a method of managing a cache of files that are stored by a browser, which is carried out by specifying a selection criterion applying to at least a portion of the files in the cache, receiving an indication that a session of the browser has terminated, and responsively to the indication and to the selection criterion, deleting one or more of the files from the cache without deleting all of the files from the cache.

According to one aspect of the method, the selection criterion is a match between names of the files and a member of a set of qualified file names.

According to another aspect of the method, the selection criterion is a match between sources of the files and a member of a set of qualified sources.

Another aspect of the method includes disabling automatic deletion of the cache of files in the browser.

In one aspect of the method, the browser accesses content via a data network and stores the content as files in the cache, wherein specifying the selection criterion comprises specifying at least one of a set of qualified sources of the files and a set of qualified file names of the files. After receiving the indication that the session of the browser has terminated, The method is further carried out by identifying files in the cache whose sources fail to match at least one of the qualified sources, or whose file names fail to match at least one of the qualified file names, or both. The identified files are deleted from the cache.

A further aspect of the method the qualified sources and the qualified file names are specified respectively as first regular expressions and second regular expressions, and identifying is performed by determining whether the sources of the files match the first regular expressions, and whether the file names of the files match the second regular expressions.

The invention provides a computer software product, including a computer-readable medium in which computer program instructions are stored, which instructions, when read by a computer, cause the computer to perform a method of managing a cache of files that are stored by a browser, which is carried out by specifying a selection criterion applying to a portion of the files in the cache, receiving an indication that a session of the browser has terminated, and responsively to the indication and to the selection criterion, deleting one or more of the files from the cache without deleting all of the files from the cache.

The invention provides a data processing system for managing a cache of files that are stored by a browser, the files has sources and file names, including a processor, connected to a data network, the browser accessing content via the data network and storing the content in the files. A memory accessible by the processor has stored therein qualified sources of the files and qualified file names of the files. The processor is operative for receiving an indication that a session of the browser has terminated and thereafter identifying ones of the files that fail to match a predetermined selection criterion, and responsively to the indication and to the selection criterion, deleting one or more of the identified files from the cache without deleting all of the files from the cache.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a high level diagram of a system which is constructed and operative in accordance with a disclosed embodiment of the invention;

FIG. 2 is a block diagram illustrating the architecture of the browser of the system shown in FIG. 1 accordance with a disclosed embodiment of the invention; and

FIG. 3 is a flow chart describing a method of browser cache management in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

### SYSTEM OVERVIEW

Turning now to the drawings, reference is initially made to FIG. 1, which is a high level diagram of a system 10, which is suitable for carrying out the present invention. The system 10 is built around a general purpose computer 12, which is provided with a memory 14 for storage of executables and data. The memory 14 is typically realized as a hard disk. Alternatively, the computer 12 may use other known types of memory alone or in combination with the hard disk as the memory 14. In particular, the memory 14 stores applications including a browser 16, and has a reserved area for a cache 18 of temporary files 20. In a current embodiment, the browser 16 is realized as Internet Explorer. This is by way of example and not of limitation. The principles of the invention can be applied to many other browsers. The files 20 contain various forms of downloaded content, which is displayed for a user 22 during a browser session. As noted above, the content can be in various formats, including graphics files, documents formatted in a markup language such as HTML, and documents formatted in many other known document formats. The computer 12 is linked to a data network 24, which can be the Internet. The network 24 typically links the computer 12 to many different servers, all of which are accessible using the browser 16. These servers are shown representatively in FIG. 1 as a single server 26. The server 26 and other servers (not shown) serve as content sources from which the files 20 are downloaded via the network 24.

Local Cache Profile

Continuing to refer to FIG. 1, when operating in the above-noted Enterprise Portal environment, in addition to the content formats mentioned above, the cache 18 also stores specialized portal applications known as iViews, which are applications that retrieve content from servers to the portal user in the form of integrated views of back-end systems. The cache 18 may also store other types of portal content. This caching capability enhances the performance of the portal and reduces the overall workload on the network resources. The computer 12 is able to re-present the locally cached content faster than if the content were to be repeatedly downloaded from the server 26 over the network 24.

However, caching has its drawbacks. Many enterprises refrain from using the browser caching facilities in order to protect sensitive information. Since the information is typically stored in a subdirectory in the memory 14, it is potentially available to unauthorized personnel. In Internet Explorer, one of the features used to disable the browser cache is a built-in configuration option, termed “Empty Temporary Internet Folder when browser is closed”. Enabling this option eliminates the cached files, but slows the performance of the browser when the same information is required in a subsequent session.

Actually, a large amount of data that is transferred to the browser and cached does not contain sensitive information. Rather, it consists mostly of resources, such as JavaScript™, themes, style elements, and graphics, which are either completely static, or do not change very often.

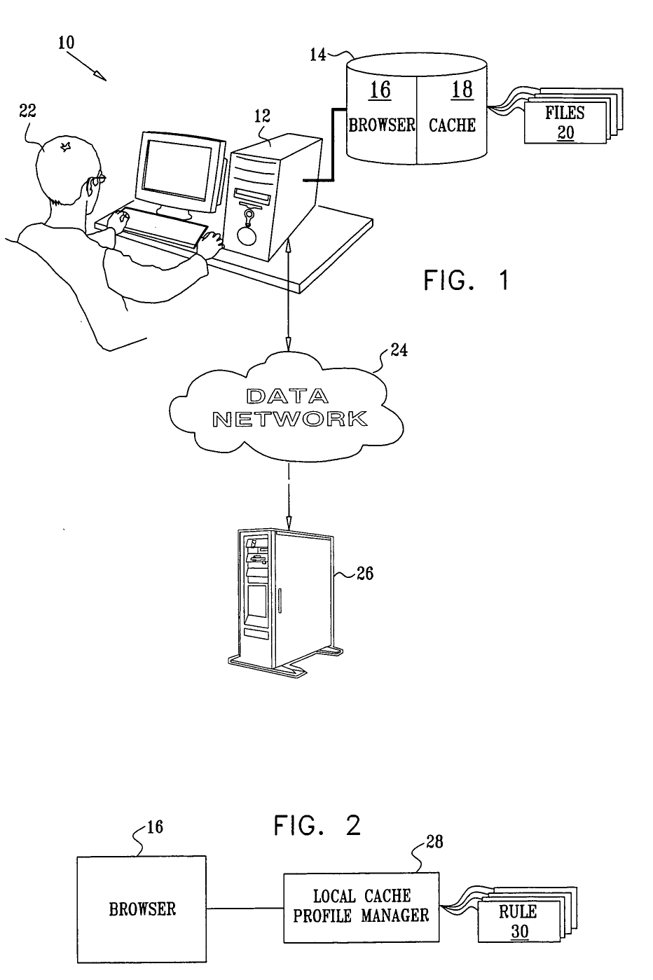

Reference is now made to FIG. 2, which is a block diagram illustrating the architecture of the browser 16 of the system 10 (FIG. 1) in accordance with a disclosed embodiment of the invention. In this embodiment, the browser 16 can be realized as Microsoft's Internet Explorer, which cooperates with a browser plug-in that functions as a local cache profile manager 28. Alternatively, many other browsers can be used as the browser 16. When enabled, the local cache profile manager 28 is configured as follows: (1) rules 30 are defined, which enable the local cache profile manager 28 to operate on the types of data available to the user 22 (FIG. 1), examples of which are shown below in Listing 1 and Listing 2; and (2) the local cache profile manager 28 discriminates objects and resources that should be stored in the cache 18 from those that should not remain in the cache 18 according to predetermined selection criteria.

Implementation

The local cache profile manager 28 (FIG. 2) includes four files: three modules, stored as dynamic link library (DLL) files, and one INI file, as summarized in Table 1. In a distributed environment, all the files must be deployed and in the case of IECacheMgr.dll, registered in each client. In the current embodiment, the DLL files are compatible with the Microsoft Windows® operating system. However, modules having the same functionality for use with other operating systems will occur to those skilled in the art. The following description is generally directed to implementation in a distributed network environment, such as the above-noted Enterprise Portal environment. However, it will be apparent that the configuration can be readily modified for single users, or for use with other networks.

TABLE 1

| File name | Description |
|---|---|
| IECacheMgr.dll | Listens on browser events. |
| IECacheExplorer.dll | Provides basic operations for determining |
| | the nature of the data in the browser, |
| | using patterns to retrieve and delete |
| | data in the browser's cache. |
| Pcre.dll | A regular expression library. |
| Iecachemgr.ini | Specifies the settings for customizing a |
| | client's browser cache. |

The purpose of the file, IECacheMgr.dll, is to detect browser events. It should be noted, that for the local cache profile manager 28 to operate, the Internet Explorer option, “Empty Temporary Internet Folder when browser is closed” must be disabled, in order to prevent automatic deletion of all cache files when a browser session terminates. The local cache profile manager 28 begins its principal operation when the browser session terminates, that is when the last open browser window is closed.

The local cache profile manager 28 is activated when the user 22 (FIG. 1) opens a browser window. Later, when the session eventually terminates, basic operations of the local cache profile manager 28 are provided by the file IECacheExplorer.dll, which operates on received data, searching for a match for the names of the servers specified in the settings file. In addition, it looks for a match for all the file types of the resources specified in the settings file. Only when matches are found for both the sources and types of resource, is the incoming data retained in the browser cache. The local cache profile manager 28 operates regardless of the number of browser windows opened by the user 22.

The settings file, iecachemgr.ini, contains two sets of lists, which are arranged in sections, as described in Table 2. It should be noted that the.ini file can be edited using a text editor. The entries in the settings file include qualified sources or hosts, and qualified file names or file types that may be retained in a browser cache. In some embodiments of the invention, these entries are stored as regular expressions, which can be matched against cache files. In the present embodiment, adequate matching can be achieved using a limited implementation of the rules for matching regular expressions. Regular expressions are a well-known method of compactly representing string patterns as templates formed by sets of symbols and syntactic elements. Alternatively, other known matching techniques may be used. Indeed, the entries could be stored in a binary format, and matched accordingly. Alternatively, the entries could be stored in sort order. Many matching techniques will occur to those skilled in the art.

The file Pcre.dll, available, for example, at the URL “http://www.dll-files.com/dllindex/dllfiles.shtml?pcre”, is a library that contains program code used for performing regular expression processing of string data.

TABLE 2

| Section | Description |
|---|---|
| Hosts | Defines the text strings for the name of portal |
| | server, machine names, and Web sites to be used |
| | in the regular expressions component (see |
| | below) to determine whether data received from |
| | the specified hosts should be cached or not. |
| Files | Specifies one or more file types for resources |
| | that can be cached. The Local Cache Profile |
| | specifies how the client browser cache should |
| | manage data for these resources. |
| Trace | Used for debugging purposes only. |
| | Default value is off. When modified to turn on |
| | the trace, a new log file is created in the |
| | same folder as the INI file on the client. |

### EXAMPLE 1

The following exemplifies an editing session with the settings file, iecachemgr.ini, in order to customize the local cache profile manager 28. The file is opened with a text editor.

In the section entitled Hosts, the name of the portal server is entered. In addition, the names of other Web sites may be entered. The following syntax is used for specifying various formats of the text strings for hosts, as shown in Listing 1.

### LISTING 1

[hosts] ;Section for list of the sites
host1=p022069\.tlv\.sap\.corp:50000
host2=www\.google\.com
host3=.\.walla\.co

Listing 2 illustrates file type entries for which caching is to be available. These entries are placed in the section entitled Files. Once the appropriate entries have been made, the file is saved and closed.

### LISTING 2

[files] ;Section for list of the resources
file1=.*\.css
file2=.*\.js
file3=.*\irj/portalapps/.*/themes.*\.gif
file4=.*\irj/portalapps/.*/themes.*\.jpg
file5=.*\logon/layout/.*\.gif
file6=.*\logon/layout/.*\.jpg
file7=.*\.gif

Operation

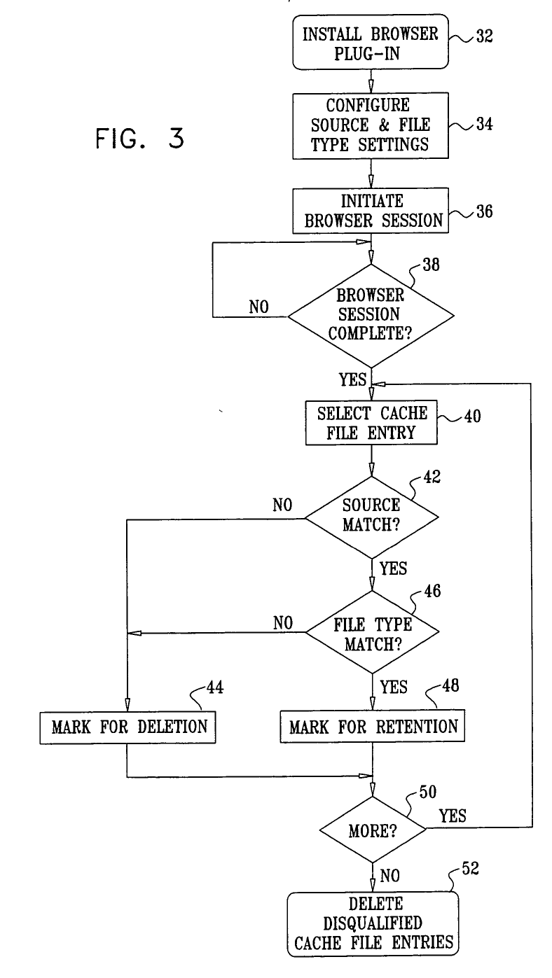

Reference is now made to FIG. 3, which is a flow chart describing a method of browser cache management in accordance with a disclosed embodiment of the invention. The process steps are shown in a particular sequence in FIG. 3 for clarity of presentation. However, it will be evident that many of them can be performed in parallel, asynchronously, or in different orders.

The method begins at initial step 32, in which configuration of the computers used for browsing occurs. A local cache profile manager is installed in each machine as a browser plug-in. Typically a common path is established for each client computer for convenience of administration, e.g., “C:\Documents and Settings\All Users\Application Data\”. The browser is conditioned for operation with the local cache profile manager by disabling the option, “Empty Temporary Internet Folder when browser is closed” or its equivalent in browsers other than Internet Explorer.

Next, at step 34 the settings file for the local cache profile manager is customized by inserting a list of sources and file types. These entries form the basis for pattern matching rules that are to be applied to candidates for retention in the browser cache when the browser session terminates.

Next, at step 36 a browser session is initiated. This activates the local cache profile manager. The browser accesses sources and pages, as directed by the user. As information is received, cache files are stored conventionally.

Next, at delay step 38 termination of the browser session is awaited.

When the browser closes, control proceeds to step 40, which begins a sequence in which the files stored in the browser cache are evaluated. This can be accomplished using the Windows application programming interface (API) WINInet, which is a set of functions that enable applications to interact with various protocols, e.g., Gopher, FTP, and HTTP. For example, the WINInet API provides functions for enumerating all cache elements, identifying the host of origin, the URL used to fetch it, and the physical file name under it is stored. At step 40, one of the cache files is chosen. In practice, step 40 can be preceded by populating a vector of cache files.

Control now proceeds to decision step 42, where it is determined if the current cache file entry matches one of the sources that were entered in the settings file at step 34. This is accomplished by treating the current file entry as a string to be matched with the regular expressions representing all the sources listed in the settings file, using a pattern matching function.

If the determination at decision step 42 is negative, then the current file entry does not qualify for retention in the cache. Control proceeds to step 44, which is described below.

If the determination at decision step 42 is affirmative, then one of two tests required for cache file retention has been passed. Control now proceeds to decision step 46, where it is determined if the current cache file entry matches one of the file types that were entered in the settings file at step 34. Pattern matching of regular expressions is employed, as in decision step 42.

If the determination at decision step 46 is negative, then the current file entry does not qualify for retention in the cache. Control proceeds to step 44, which is described below. In some applications it may be desirable to exchange the order of decision steps 42, 46 in order to optimize performance. It should be noted that while the selection criteria employed in decision steps 42, 46 are used in a current embodiment, many other predetermined selection criteria could be substituted in one or both of these steps. For example, a less severe deletion policy would retain cache files unless they failed to match both sources and file names.

If the determination at decision step 46 is affirmative, then control proceeds to step 48. The current entry is marked for retention. This can be accomplished by populating another vector with cache files that are to be retained.

Step 44 is performed if the determination of either decision step 42 or decision step 46 is negative. The current entry is marked for deletion. In some embodiments, the current entry may actually be deleted at this stage. In other embodiments, nothing need be done in step 44. Failure to include the current entry in the vector of cache files that are to be retained is a sufficient indicator for its deletion. In still other embodiments, a vector of disqualified cache files is populated in step 44.

Following performance of either of steps 48, 44, Control proceeds to decision step 50, where it is determined if more cache files remain to be processed. If the determination at decision step 50 is affirmative, then control returns to step 40.

If the determination at decision step 50 is negative, then control proceeds to final step 52. In embodiments in which cache files that were disqualified for retention were not already deleted in step 44, then each cache file entry is evaluated for a match in the vector that was populated in step 48. All cache files that fail to match this vector are now deleted. Alternatively, if a vector were populated in step 44, then cache files in this vector are deleted. The procedure then terminates. In the present embodiment, due to characteristics of the current versions of Internet Explorer, it has been found that WINInet API cannot be relied upon to delete the files in either alternative. It has been found that the files found on the disk do not necessarily correspond to the files reported by the WINInet API. Thus, all physical files are deleted using standard file system calls, except for files that were found to be qualified for retention using the WINInet API. It will be understood that some embodiments may be executed under operating systems other than Microsoft Windows, in which case appropriate substitutes for the WINInet API can be exploited if available. Otherwise, standard file system calls are used.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method of managing a cache of files that are stored by a browser, comprising:
specifying a selection criterion applying to at least a portion of said files in said cache;
receiving an indication that a session of said browser has terminated; and
responsively to said indication and to said selection criterion, deleting one or more of said files from said cache without deleting all of said files from said cache.

2. The method according to claim 1, wherein said selection criterion is a match between names of said files and a member of a set of qualified file names.

3. The method according to claim 1, wherein said selection criterion is a match between sources of said files and a member of a set of qualified sources.

4. The method according to claim 1, further comprising the step of disabling automatic deletion of said cache of files in said browser.

5. The method according to claim 1, wherein said files have sources and file names, wherein said browser accesses content via a data network and stores said content as said files, wherein said step of specifying comprises specifying at least one of a set of qualified sources of said files and a set of qualified file names of said files;
further comprising the steps of:
after receiving said indication performing the steps of:
identifying at least one of first ones of said files in said cache, wherein said sources thereof fail to match at least one of said qualified sources, and second ones of said files in said cache, wherein said file names thereof fail to match at least one of said qualified file names; and
deleting said identified first ones and said identified second ones from said cache.

6. The method according to claim 5, wherein said step of specifying comprises specifying both of said set of qualified sources and said set of qualified file names, and said step of identifying comprises identifying both of said first ones and said second ones.

7. The method according to claim 5, wherein said qualified sources and said qualified file names are specified respectively as first regular expressions and second regular expressions, and said step of identifying said first ones comprises determining whether said sources of said files match said first regular expressions; and said step of identifying said second ones comprises determining whether said file names of said files match said second regular expressions.

8. A computer software product, including a computer-readable medium in which computer program instructions are stored, which instructions, when read by a computer, cause the computer to perform a method for managing a cache of files that are stored by a browser, comprising:
accepting as an input a predetermined selection criterion applying to at least a portion of said files in said cache; receiving an indication that a session of said browser has terminated; and
responsively to said indication and to said selection criterion, deleting one or more of said files from said cache without deleting all of said files from said cache.

9. The computer software product according to claim 8, wherein said selection criterion is a match between names of said files and a member of a set of qualified file names.

10. The computer software product according to claim 8, wherein said selection criterion is a match between sources of said files and a member of a set of qualified sources.

11. The computer software product according to claim 8, wherein said computer is further instructed to perform the step of disabling automatic deletion of said cache of files in said browser.

12. The computer software product according to claim 8, wherein said files have sources and file names, wherein said browser accesses content via a data network and stores said content as said files, wherein said input comprises a specification of at least one of a set of qualified sources of said files and a set of qualified file names of said files, further comprising the steps of:
after receiving said indication performing the steps of:
identifying at least one of first ones of said files in said cache, wherein said sources thereof fail to match at least one of said qualified sources, and second ones of said files in said cache, wherein said file names thereof fail to match at least one of said qualified file names; and
deleting said identified first ones and said identified second ones from said cache without deleting all of said files from said cache.

13. The computer software product according to claim 12, wherein said specification comprises both of said set of qualified sources and said set of qualified file names, and said step of identifying comprises identifying both of said first ones and said second ones.

14. The computer software product according to claim 12, wherein said qualified sources and said qualified file names are specified respectively as first regular expressions and second regular expressions, and said step of identifying said first ones comprises determining whether said sources of said files match said first regular expressions; and said step of identifying said second ones comprises determining whether said file names of said files match said second regular expressions.

15. A data processing system for managing a cache of files that are stored by a browser, said files having sources and file names, comprising:
a processor, connected to a data network, said browser accessing content via said data network and storing said content as said files;
a memory accessible by said processor having stored therein qualified sources of said files and qualified file names of said files;
said processor being operative for receiving an indication that a session of said browser has terminated and thereafter performing the steps of:
identifying ones of said files that fail to match a predetermined selection criterion; and
responsively to said indication and to said selection criterion, deleting one or more of said identified files from said cache without deleting all of said files from said cache.

16. The data processing system according to claim 15, wherein said selection criterion is a match between names of said files and a member of a set of qualified file names.

17. The data processing system according to claim 15, wherein said selection criterion is a match between sources of said files and a member of a set of qualified sources.

18. The data processing system according to claim 15, wherein said selection criterion comprises:
identifying first ones of said files in said cache, wherein said sources thereof fail to match at least one of said qualified sources;
identifying second ones of said files in said cache, wherein said file names thereof fail to match at least one of said qualified file names; and
deleting said identified first ones and said identified second ones from said cache.

19. The data processing system according to claim 18, wherein said qualified sources and said qualified file names are specified respectively as first regular expressions and second regular expressions, and said step of identifying first ones comprises determining whether said sources of said files in said cache match said first regular expressions; and said step of identifying second ones comprises determining whether said file names of said files in said cache match said second regular expressions.

20. The data processing system according to claim 15, wherein said memory has stored therein a plug-in that is adapted to said browser.

21. The data processing system according to claim 20, wherein said plug-in comprises a first module for detecting events occurring in said browser, a second module for performing operations on said cache of files, a third module having functions for matching regular expressions, and a settings file for storing said qualified sources and said qualified file names.
